(19) United States
(12) Patent Application Publication
(10) Pub. No.: US 2011/0025582 A1
(43) Pub. Date: Feb. 3, 2011

(54) DISPLAY DEVICE

(75) Inventors: Nam-Seok ROH, Seongnam-si, (KR); Young-Chol YANG, Kunpo-si (KR); Keun-Kyu SONG, Seongnam-si (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/891,006

(22) Filed: Sep. 27, 2010

Related U.S. Application Data
(62) Division of application No. 10/581,573, filed on Jun. 2, 2006.

(30) Foreign Application Priority Data
Dec. 3, 2003 (KR) 10-2003-0087127
Dec. 4, 2003 (KR) 10-2003-0087593

(51) Int. Cl. G09G 3/20

(52) U.S. Cl. 345/55

(57) ABSTRACT

A display device is provided, which includes, a plurality of pixels arranged in a matrix, each pixel including a first set of three primary color subpixels (R, G, B) and at least one of a second set of three primary color subpixels, (C, M, Y) wherein the first and the second sets of three primary colors have a complementary relation.

### CROSS REFERENCE TO RELATED APPLICATIONS

This application is a divisional application of U.S. application Ser. No. 10/581,573 filed Jun. 2, 2006, which is the U.S. National Stage of application PCT/KR2004/003151 having an International Filing Date of Dec. 2, 2004, which claims priority to and the benefit of Korean Patent Application No. 10-2003-0087127 filed on Dec. 3, 2003 and Korean Patent Application No. 10-2003-0087593 filed on Dec. 4, 2003, all of which are incorporated by reference herein in their entirety.

### TECHNICAL FIELD

The present invention relates to a display device.

### BACKGROUND ART

Recently, flat panel displays such as organic light emitting displays, plasma display panels, and liquid crystal displays are widely developed

The liquid crystal display (LCD) is a representative of the flat panel displays. The LCD includes a liquid crystal (LC) panel assembly including two panels provided with two kinds of field generating electrodes such as pixel electrodes and a common electrode and a LC layer with dielectric anisotropy interposed therebetween. The variation of the voltage difference between the field generating electrodes, i.e, the variation in the strength of an electric field generated by the electrodes changes the transmittance of the light passing through the LCD, and thus desired images are obtained by controlling the voltage difference between the electrodes.

The LCD includes a plurality of pixels including three sub-pixels representing red, green and blue colors.

However, the three primary color system has a limit in color reproductivity for some ranges of colors. In detail, the commercially available display device can represent the colors determined by NTSC (national television system committee) or EBU (European broadcasting union). However, the colors determined by NTSC or EBU occupy only about 90% of natural colors and thus remaining 10% colors cannot be correctly represented In particular, the LCD represents only 70% of the colors determined by NTSC.

### DISCLOSURE OF INVENTION

### Technical Problem

A motivation of the present invention is to solve the problems of the conventional technique.

### Technical Solution

A display device is provided, which includes: a plurality of pixels arranged in matrix, each pixel including a first set of three primary color subpixels and at least one of a second set of three primary color subpixels, wherein the first and the second sets of three primary colors have a complementary relation.

The first set of three primary color subpixels may include red green, and blue subpixels, and the second set of three primary color subpixels may include cyan, magenta, and yellow subpixels.

The red and the blue subpixels may be arranged in a row and the red and the green subpixels may be arranged in a column.

A display device is provided which includes: a plurality of pixels arranged in mat rix, each pixel including first to third pairs of subpixels, wherein the first pair of subpixels are disposed adjacent to each other, the second and the third sets of subpixels are disposed opposite each other with respect to the first pair of subpixels, and the first to the third sets of subpixels include first-color subpixels and second-color subpixels.

Each subpixel in the first pair of subpixels may be triangular, and the first pair of subpixels may form a diamond

A boundary between the first pair of subpixels may extend in a row or column direction.

The first-color and the second-color subpixels may have complementary relation.

The first-color subpixels may include red green, and blue subpixels, and the second-color subpixels may include cyan, magenta, and yellow subpixels.

The first-color subpixels may include red green, and blue subpixels and the second-color subpixels may include cyan, white, and yellow subpixels.

A display device is provided which includes: a matrix of pixels, each pixel including a pair of central subpixels adjacent to each other, a pair of first subpixels, and a pair of second subpixels, the pairs of first and second subpixels disposed in diagonals with respect to the central subpixels; a plurality of gate lines extending in a row direction and transmitting gate signals; and a plurality of data lines extending in a column direction and transmitting data signals, wherein each subpixel includes a pixel electrode and a thin film transistor, the subpixels include first and second sets of three primary color subpixels, and the first and the second sets of three primary color subpixels have complementary relation.

Each of the central subpixels may be isosceles triangular and the central subpixels may form a diamond

A boundary between the central subpixels may extend in a row or column direction.

The first set of three primary color subpixels may include red green, and blue subpixels, and the second set of three primary color subpixels may include cyan, magenta, and yellow subpixels.

### ADVANTAGEOUS EFFECTS

The multi-color configuration including at least one color in adition to red green, and blue colors increases the reproductivity of colors.

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a subpixel of an LCD according to an embodiment of the present invention;

FIG. 3 shows arrangements of four four-color subpixels of an LCD according to embodiments of the present invention.

FIG. 4 is a layout view of a TFT array panel according to an embodiment of the present invention;

FIG. 5 is a sectional view of the TFT array panel shown in FIG. 4 taken along the line V-V′;

FIGS. 6 and 7 show arrangements of six six-color subpixels of an LCD according to embodiments of the present invention;

FIG. 8 is an exemplary layout view of a TFT array panel for an LCD having the subpixel configuration shown in FIG. 6;

FIG. 9 is an exemplary layout view of a TFT array panel for an LCD having the subpixel configuration shown in FIG. 7;

FIG. 10 is a sectional view of the TFT array panel shown in FIG. 9 taken along the line X-X′;

FIG. 11 illustrates a color coordinate system; and

FIG. 12 is a table illustrating the thickness of magenta color filters in unit of microns, color coordinates, and relative luminance.

### BEST MODE FOR CARRYING OUT THE INVENTION

The present invention now will be described more fully hereinafter with reference to the accompanying drawings, in which embodiments of the invention are shown.

In the drawings, the thickness of layers and regions are exaggerated for clarity. Like numerals refer to like elements throughout. It will be understood that when an element such as a layer, region or substrate is referred to as being on another element, it can be directly on the other element or intervening elements may also be present. In contrast, when an element is referred to as being directly on another element, there are no intervening elements present.

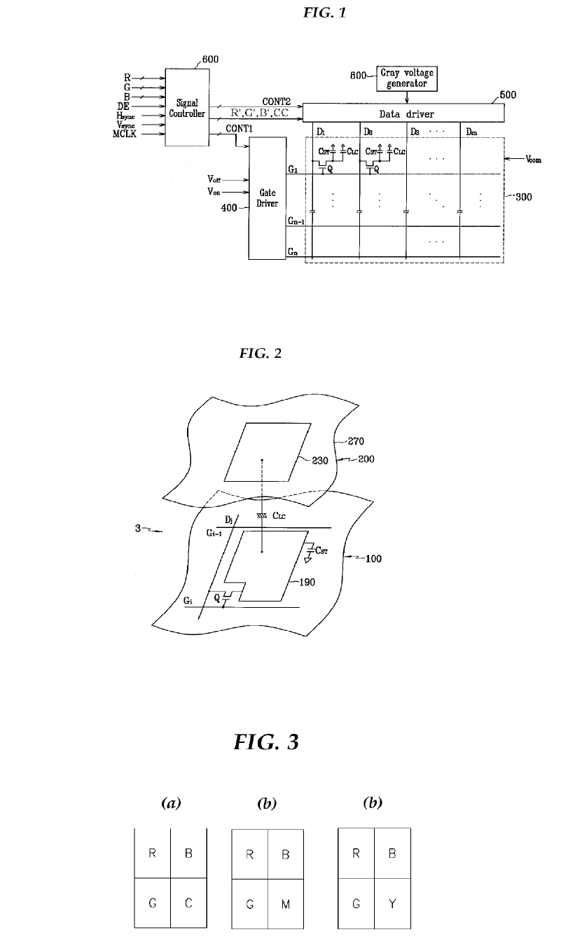

FIG. 1 is a block diagram of an LCD according to an embodiment of the present invention, and FIG. 2 is an equivalent circuit diagram of a subpixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator 800 connected to the data driver 500, and a signal controller 600 controlling the above elements.

Referring to FIG. 1, the panel assembly 300 includes a plurality of display signal lines G₁-Gₙ and D₁-Dₘ and a plurality of subpixels connected thereto and arranged substantially in a matrix. In a structural view shown in FIG. 2, the panel assembly 300 includes lower and upper panels 100 and 200 and a LC layer 3 interposed therebetween.

The display signal lines G₁-Gₙ and D₁-Dₘ) are disposed on the lower panel 100 and include a plurality of gate lines G₁-Gₙtransmitting gate signals (also referred to as scanning signals), and a plurality of data lines D₁-Dₘ transmitting data signals. The gate lines G₁-Gₙ extend substantially in a row direction and substantially parallel to each other, while the data lines D₁-Dₘ extend substantially in a column direction and substantially parallel to each other.

Each subpixel includes a switching element Q connected to the signal lines G₁-Gₙ and D₁-Dₘ, and a LC capacitor C and a storage capacitor C that are connected to the switching element Q. If unnecessary, the storage capacitor C_{ST} may be omitted

The switching element Q including a TFT is provided on the lower panel 100 and has three terminals: a control terminal connected to one of the gate lines G₁-Gₙ; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q, and the common electrode 270 is supplied with a common voltage Vcom and covers an entire surface of the upper panel 200. Unlike FIG. 2, the common electrode 270 may be provided on the lower panel 100, and both electrodes 190 and 270 may have shapes of bars or stripes.

The storage capacitor C_{ST} is an auxiliary capacitor for the LC capacitor C_{LC}. The storage capacitor C_{ST} includes the pixel electrode 190 and a separate signal line, which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each subpixel uniquely represents one of primary colors (i.e., spatial division) or each subpixel sequentially represents the primary colors in turn (i.e., temporal division) such that spatial or temporal sum of the primary colors are recognized as a desired color. FIG. 2 shows an example of the spatial division that each subpixel includes a color filter 230 representing one of the primary colors in an area of the upper panel 200 facing the pixel electrode 190. Alternatively, the color filter 230 is provided on or under the pixel electrode 190 on the lower panel 100.

An example of a set of the primary colors includes first three primary colors including red, green, and blue colors and at least one of second three primary colors complementary to the first three primary colors, i.e., cyan, magenta, and yellow colors. However, magenta may be substituted with white or transparency.

One or more polarizers (not shown) are attached to at least one of the panels 100 and 200.

Referring to FIG. 1 again, the gray voltage generator 800 generates two sets of a plurality of gray voltages related to the transmittance of the subpixels. The gray voltages in one set have a positive polarity with respect to the common voltage Vcom, while those in the other set have a negative polarity with respect to the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternately, the drivers 400 and 500 may be integrated into the panel assembly 300 along with the display signal lines G₁-Gₙ and D₁-Dₘ and the TFT switching elements Q.

The signal controller 600 controls the gate driver 400 and the gate driver 500.

Now, the operation of the above-described LCD will be described in detail.

The signal controller 600 is supplied with input three-color image signals R, G and B and input control signals controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and converting and processing the input image signals R, G and B into multi-color image signals R′, G′, B′ and CC suitable for the operation of the panel assembly 300 on the basis of the input control signals and the input image signals R, G and B, the signal controller 600 transmits the gate control signals CONTI to the gate driver 400, and the processed image signals R′, G′, B′ and CC and the data control signals CONT2 to the data driver 500. Reference numeral CC denotes an image signal for a subpixel representing at least one of the second three primary colors.

The gate control signals CONT1 include a scanning start signal STV for instructing to start scanning and at least a clock signal for controlling the output time of the gate-on voltage Von. The gate control signals CONT1 may further include an output enable signal OE for defining the oration of the gate-on voltage Von.

The data control signals CONT2 include a horizontal synchronization start signal STH for informing of start of data transmission for a group of subpixels, a load signal LOAD for instructing to apply the data voltages to the data lines D₁-Dₙ and a data clock signal HCLK. The data control signal CONT2 may further include an inversion signal RVS for reversing the polarity of the data voltages (with respect to the common voltage Vcom).

Responsive to the data control signals CONT2 from the signal controller 600, the data driver 500 receives a packet of the image data R′, G′, B′ and CC for the group of subpixels from the signal controller 600, converts the image data R′, G′, B′ and CC into analog data voltages selected from the gray voltages supplied from the gray voltage generator 800, and applies the data voltages to the data lines D₁-Dₘ.

The gate driver 400 applies the gate-on voltage Von to the gate line G₁-Gₙ in response to the gate control signals CONTI from the signal controller 600, thereby turning on the switching elements Q connected thereto. The data voltages applied to the data lines D₁-Dₘ are supplied to the subpixels through the activated switching elements Q.

The difference between the data voltage and the common voltage Vcom is represented as a voltage across the LC capacitor C_{LC}, which is referred to as a subpixel voltage. The LC molecules in the LC capacitor C_{LC} have orientations depending on the magnitude of the subpixel voltage, and the molecular orientations determine the polarization of light passing through the LC layer 3. The polarizer(s) converts the light polarization into the light transmittance.

By repeating this procedure by a unit of the horizontal period (which is denoted by 1H and equal to one period of the horizontal synchronization signal Hsync and the data enable signal DE), all gate lines G₁-Gₙ are sequentially supplied with the gate-on voltage Von daring a frame, thereby applying the data voltages to all subpixels. When the next frame starts after finishing one frame, the inversion control signal RVS applied to the data driver 500 is controlled such that the polarity of the data voltages is reversed (which is referred to as frame inversion). The inversion control signal RVS may be also controlled such that the polarity of the data voltages flowing in a data line in one frame are reversed (for example, line inversion and dot inversion), or the polarity of the data voltages in one packet are reversed (for example, column inversion and dot inversion).

In the meantime, a dot or a pixel that is a basic unit for displaying an image according to embodiments of the present invention includes red green, and blue subpixels and at least one of cyan, magenta, and yellow subpixels. Generally, the colors are determined by dominant wavelength and the luminance of a color is determined by the intensity of the dominant wavelength. In this respect, the three brightest subpixels are yellow, cyan, and green subpixels in sequence, while blue subpixels are the darkest and red and magenta subpixels are intermediate.

Now, subpixel arrangements of a pixel including four-color subpixels on the panel assembly according to embodiments of the present invention will be described in detail with reference to FIG. 3.

Hereinafter, a subpixel is referred to as red, green, blue, cyan, magenta, and yellow subpixel depending on the color represented by the subpixel and the red, green, blue, cyan, magenta, and yellow subpixels are denoted by reference characters R, G, B, C, M, and Y, respectively, which also denote the image signals for the colors.

FIG. 3 shows arrangements of four four-color subpixels of an LCD according to embodiments of the present invention.

Referring to FIG. 3, the subpixels forming a pixel are arranged in a 2×2 matrix that includes a first row including red and blue subpixels R and B and a second row including a green subpixel and one of cyan, magenta, and yellow subpixels C, M and Y (indicated by (a), (b), and (c), respectively). The 2×2 matrix is approximately square and each subpixel may be square.

The arrangements shown in FIG. 3 are only examples of possible arrangements and the arrangements may be determined in consideration of complementary relation between the colors. The multi-color configuration including at least one color in addition to red, green, and blue colors increases the reproductivity of colors.

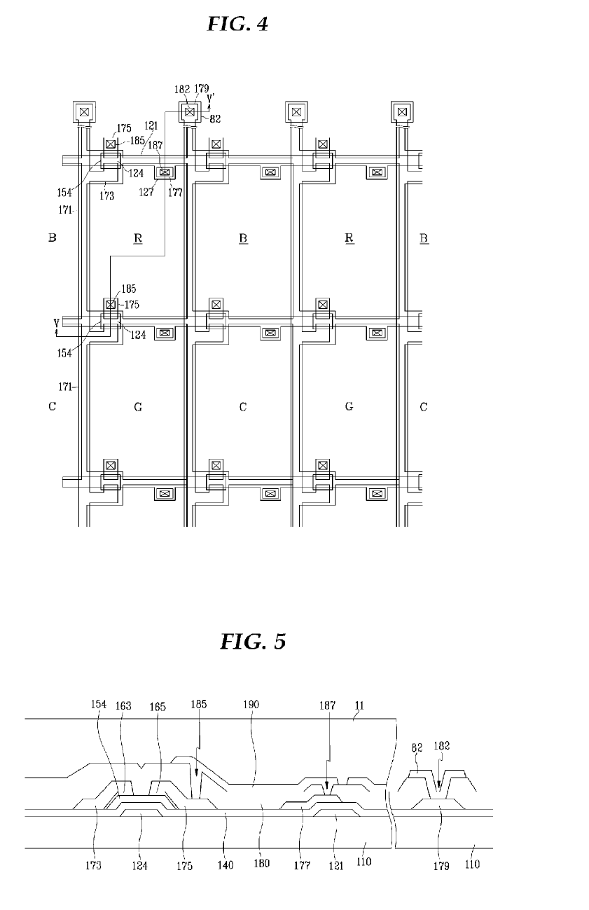

Now, a lower panel, i.e., a TFT array panel for an LCD having a subpixel arrangement shown in FIG. 3 will be described in detail with reference to FIGS. 4 and 5 as well as FIG. 2.

FIG. 4 is a layout view of a TFT array panel according to an embodiment of the present invention, and FIG. 5 is a sectional view of the TFT array panel shown in FIG. 4 taken along the line V-V′.

A plurality of gate lines 121 for transmitting gate signals are formed on an insulating substrate 110. Each gate line 121 extends substantially in a transverse direction and includes a plurality of gate electrodes 124 and a plurality of projections 127 protruding downward Each gate line 121 may extend to be connected to a gate driver (not shown) that may be integrated on the substrate 110 or may have an end portion having a large area for contact with another layer or a gate driver that may be mounted on the substrate 110 or on an external device such as a flexible printed circuit (FPC) film (not shown), which may be attached to the substrate 110.

The gate lines 121 are preferably made of Al containing metal such as Al and Al alloy, Ag containing metal such as Ag and Ag alloy, Cu containing metal such as Cu and Cu alloy, Mo containing metal such as Mo and Mo alloy, Cr, Ti or Ta. The gate lines 121 may have a multi-layered structure including two films having different physical characteristics. One of the two films is preferably male of low resistivity metal including Al containing metal, Ag containing metal, and Cu containing metal for reducing signal delay or voltage drop in the gate lines 121 and the storage electrode lines 131. The other film is preferably made of material such as Mo containing metal, Cr, Ta or Ti, which has goal physical, chemical, and electrical contact characteristics with other materials such as indium tin oxide (ITO) or indium zinc oxide (IZO). Goal examples of the combination of the two films are a lower Cr film and an upper Al (alloy) film and a lower Al (alloy) film and an upper Mo (alloy) film.

In addition, the lateral sides of the gate lines 121 are inclined relative to a surface of the substrate 110, and the inclination angle thereof ranges about 30-80 degrees.

A gate insulating layer 140 preferably made of silicon nitride (SiNx) is formed on the gate lines 121.

A plurality of semiconductor islands 154 preferably made of hydrogenated amorphous silicon (abbreviated as a-Si) or polysilicon are formed on the gate insulating layer 140. Each semiconductor island 154 is located on the gate electrodes 124.

A plurality of ohmic contact islands 163 and 165 preferably male of silicide or n+ hydrogenated a-Si heavily doped with n type impurity are formed on the semi-conductor islands 154.

The lateral sides of the semiconductor islands 154 and the ohmic contacts 163 and 165 are inclined relative to the surface of the substrate 110, and the inclination angles thereof are preferably in a range of about 30-80 degrees.

A plurality of data lines 171, a plurality of drain electrodes 175, and a plurality of storage capacitor conductors 177 are formed on the ohmic contacts 161 and 165 and the gate insulating layer 140.

The data lines 171 for transmitting data voltages extend substantially in the longitudinal direction and intersect the gate lines 121. Each data line 171 includes an end portion 179 having a larger area for contact with another layer or an external device such as a data driver.

Each data line 171 includes a plurality of source electrodes 173 projecting toward the gate electrodes 124. Each pair of the source and drain electrodes 173 and 175 are separated from each other and disposed opposite each other with respect to a gate electrode 124. A gate electrode 124, a source electrode 173, and a drain electrode 175 along with a semiconductor island 154 form a TNT having a channel formed in the a semiconductor island 154 disposed between the source electrode 173 and the drain electrode 175.

The storage capacitor conductors 177 overlap the projections 127 of the gate lines 121.

The data lines 171, the drain electrodes 175, and the storage capacitor conductors 177 are preferably made of refractory metal such as Mo containing metal, Cr, Ti, Ta or alloys thereof. However, they may also have a multilayered structure including a low-resistivity film (not shown) and a good-contact film (not shown). A goal example of the combination is a lower Mo film, an intermediate Al film, and an upper Mo film as well as the above-described combinations of a lower Cr film and an upper Al—Nd alloy film and a lower Al film and an upper Mo film.

Like the gate lines 121, the data lines 171, the drain electrodes 175, and the storage capacitor conductors 177 have inclined edge profiles, and the inclination angles thereof range about 30-80 degrees.

The ohmic contacts 161 and 165 are interposed only between the underlying semiconductor islands 154 and the overlying data lines 171 and the overlying drain electrodes 175 thereon and reduce the contact resistance therebetween. The semiconductor islands 154 include a plurality of exposed portions, which are not covered with the data lines 171 and the drain electrodes 175, such as portions located between the source electrodes 173 and the drain electrodes 175.

A passivation layer 180 is formed on the data lines 171, the drain electrodes 175, the storage electrode capacitors 177, and the exposed portions of the semiconductor stripes 151. The passivation layer 180 is preferably made of inorganic insulator such as silicon nitride and silicon oxide, photosensitive organic material having a good flatness characteristic, or low dielectric insulating material such as a-SiCO and a-Si:O:F formed by plasma enhanced chemical vapor deposition (PECVD). The passivation layer 180 may have a double-layered structure including a lower inorganic film and an upper organic film.

The passivation layer 180 has a plurality of contact holes 182, 185 and 187 exposing the end portions 179 of the data lines 171, the drain electrodes 175, and the storage conductors 177, respectively.

A plurality of pixel electrodes 190 and a plurality of contact assistants 82, which are preferably made of ITO or IZO, are formed on the passivation layer 180.

The pixel electrodes 190 are physically and electrically connected to the drain electrodes 175 through the contact holes 185 and to the storage capacitor conductors 177 through the contact holes 187 such that the pixel electrodes 190 receive the data voltages from the drain electrodes 175 and transmit the received data voltages to the storage capacitor conductors 177.

Referring to FIG. 2 again, the pixel electrodes 190 supplied with the data voltages generate electric fields in cooperation with a common electrode 270, which determine the orientations of liquid crystal molecules in a liquid crystal layer 3 disposed therebetween.

As describe above, a pixel electrode 190 and a common electrode form a liquid crystal capacitor C_{LC}, which stores applied voltages after turn-off of the TFT. A storage capacitor C_{ST} for enhancing the voltage storing capacity is implemented by overlapping the pixel electrode 190 with the gate lines 121 adjacent thereto (called previous gate lines). The capacitances of the storage capacitors, i.e., the storage capacitances are increased by providing the projections 127 at the gate lines 121 for increasing overlapping areas and by providing the storage capacitor conductors 177, which are connected to the pixel electrodes 190 and overlap the projections 127, under the pixel electrodes 190 for decreasing the distance between the terminals.

The pixel electrodes 190 overlap the gate lines 121 and the data lines 171 to increase aperture ratio but it is optional.

The contact assistants 82 are connected to the exposed end portions 179 of the data lines 171 through the contact holes 182. The contact assistants 82 protect the exposed portions 179 and complement the adhesion between the exposed portions 179 and external devices.

According to another embodiment of the present invention, the pixel electrodes 190 are made of transparent conductive polymer. For a reflective LCD, the pixel electrodes 190 are male of opaque reflective metal. In these cases, the contact assistants 82 may be made of material such as ITO or IZO different from the pixel electrodes 190.

Finally, an alignment layer 11 is coated on the surface of the substrate 110.

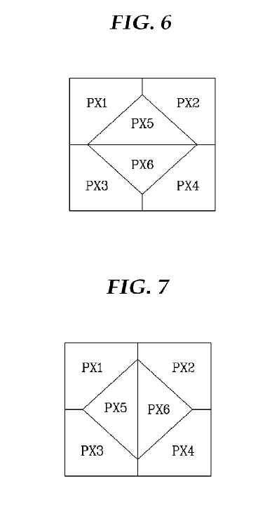

Now, subpixel arrangements of a pixel including six-color subpixels on the panel assembly according to embodiments of the present invention will be described in detail with reference to FIGS. 6 and 7.

FIGS. 6 and 7 show arrangements of six six-color subpixels of an LCD according to embodiments of the present invention.

Referring to FIGS. 6 and 7, the subpixels forming a pixel have an arrangement like a PenTile™ arrangement. The basic structure of the subpixel arrangement is a 2×2 matrix and a pair of isosceles triangle having a common bottom to form a diamond occupy the center of the 2×2 matrix. This configuration improves the image quality.

In detail, first to fourth subpixels PX1-PX4 are arranged in two rows and two columns and fifth and sixth subpixels PX5 and PX6 are centered The fifth and the sixth subpixels PX5 and PX6 shown in FIG. 6 are arranged in a column, while those shown in FIG. 7 are arranged in a row. Accordingly, the boundary between the fifth and the sixth subpixels PX5 and PX6 shown in FIG. 6 coincides with the boundary between subpixel rows, and that shown in FIG. 7 coincides with the boundary between subpixel columns.

The arrangement of the colors is determined in consideration of the complementary relation and the color interference, etc.

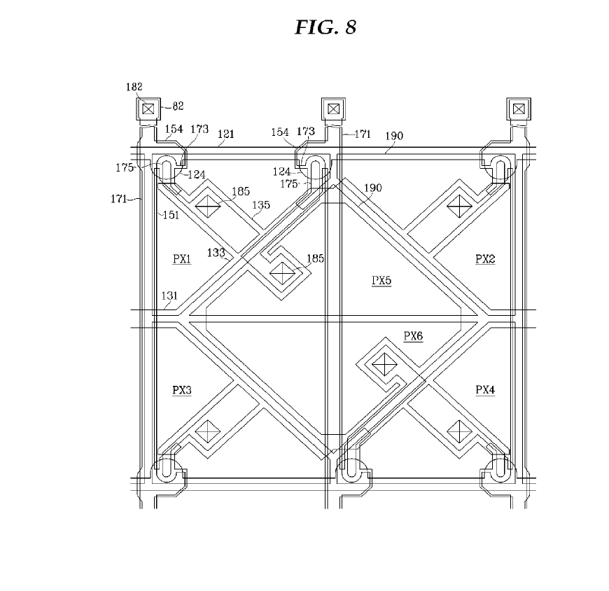

Now, TFT array panels for an LCD having subpixel arrangements shown in FIGS. 6 and 7 will be described in detail with reference to FIGS. 8-10.

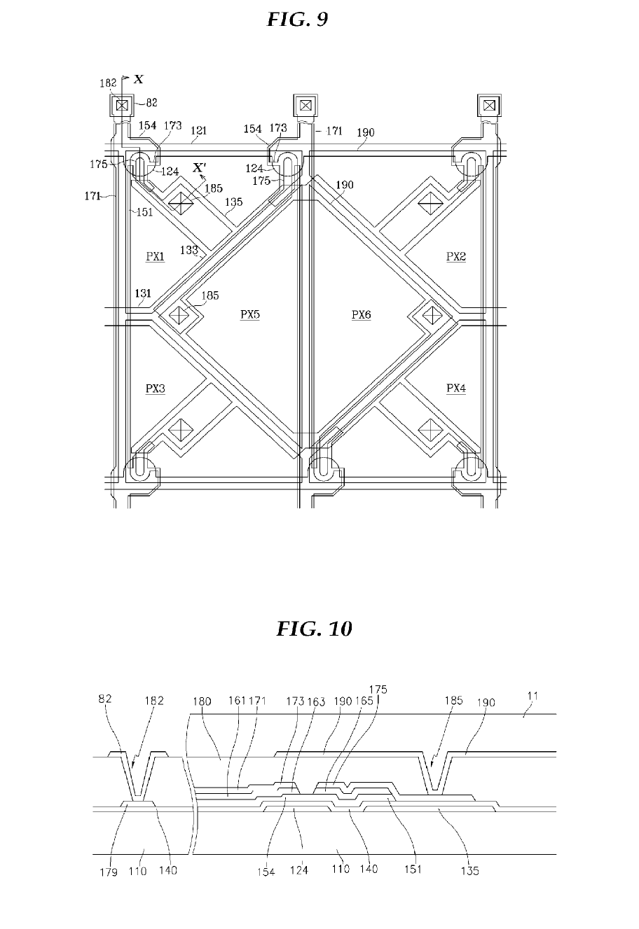

FIG. 8 is an exemplary layout view of a TFT array panel for an LCD having the subpixel configuration shown in FIG. 6, FIG. 9 is an exemplary layout view of a TFT array panel for an LCD having the subpixel configuration shown in FIG. 7, and FIG. 10 is a sectional view of the TFT array panel shown in FIG. 9 taken along the line X-X′.

Referring to FIGS. 8-10, a layered structure of the TFT array panel according to this embodiment is almost the same as those shown in FIGS. 4 and 5.

That is, a plurality of gate lines 121 including gate electrodes 124 are formed on a substrate 110, and a gate insulating layer 140, a plurality of semiconductors 154, and a plurality of ohmic contacts 163 and a plurality of ohmic contacts 165 are sequentially formed thereon. A plurality of data lines 171 including source electrodes 173 and a plurality of drain electrodes 175 are formed on the ohmic contacts 161 and 165, and a passivation layer 180 are formed thereon. A plurality of contact holes 182 and 185 are provided at the passivation layer 180 and the gate insulating layer 140. A plurality of pixel electrodes 190 and a plurality of contact assistants 82 are formed on the passivation layer 180 and an alignment layer 11 is coated thereon.

Different from the TFT array panel shown in FIGS. 4 and 5, the TFT array panel according to this embodiment provides a plurality of storage electrode lines 131, which are separated from the gate lines 121, on the same layer as the gate lines 121 without providing projections at the gate lines 121. The storage electrode lines 131 are supplied with a predetermined voltage such as the common voltage. The storage electrode lines 131 include a plurality of diamond rings 133 and a plurality of projections 135 projecting from a midpoint of respective edges of the diamond rings 133. Without providing the storage capacitor conductors 177 shown in FIGS. 4 and 5, and the drain electrodes 175 extend and expand to overlap the diamond rings 133 and the projections 135 of the storage electrode lines 131 to form storage capacitors.

In addition, the semiconductors 154 and the ohmic contacts 163 extend along the data lines 171 to form semiconductor stripes 151 and ohmic contact stripes 161. The semiconductors 151 cover edges of the gate lines 121 and the storage electrodes 131, which meet the data lines 171 and the drain electrodes 175, to smooth surface profiles, thereby preventing the disconnection of the data lines 171 and the drain electrodes 175.

The gate electrodes 124 project upward and downward and the source electrodes 173 are U or reversed U shaped.

Each of the pixel electrodes 190 are disposed on an area enclosed by the gate lines 121, the data lines 171, the diamond rings 133 of the storage electrode lines 131, or imaginary transverse lines extending from the storage electrode lines 131. The drain electrodes 175 for the center subpixels PX5 and PX6 extend along the diamond rings 133 of the storage electrode lines 131 to be connected to respective pixel electrodes 190 near the midpoint of the edges of the diamond rings 133 or the corners of the diamond rings 133.

Many of the above-described features of the TFT array panel for an LCD shown in

FIGS. 4 and 5 may be appropriate to the TFT array panel shown in FIGS. 8-10.

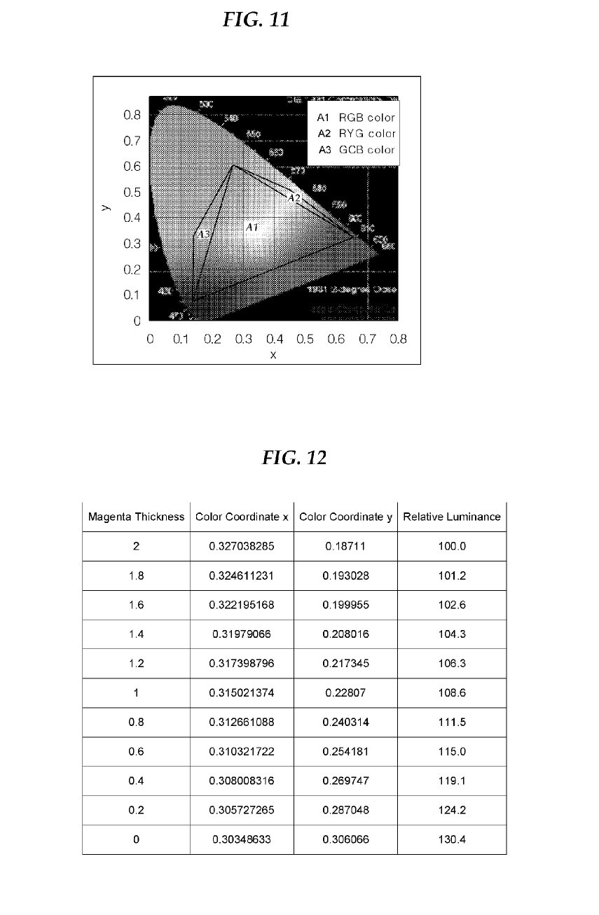

Now, the color reproductivity of the multi-color subpixel configuration will be described with reference to FIG. 11, which illustrates a color coordinate system.

In FIG. 11, the areas denoted by reference characters A1, A2 and A3 indicate color ranges reproducible by red, green, blue colors, red, yellow, and green colors, and green, cyan, and blue colors, respectively.

Accordingly, the addition of yellow and cyan colors to red, green, and blue colors increases the reproducible color range by the areas A2 and A3. It is noted that the addition of magenta may not significantly enlarge the reproducible color range. The substitution of magenta with white may increase the transmittance of light since the color filters 230 transmit only about one thirds of incident light.

Now, the variation of the luminance depending on the variation of magenta will be described with reference to FIG. 12, which is a table illustrating the thickness of magenta color filters in unit of microns, color coordinates, and relative luminance. Here, it is noted that the variation of magenta is represented by the thickness of the magenta color filters since magenta color becomes strong as a magenta filter becomes thicker.

The table shown in FIG. 12 shows that the luminance increases up to about 130% as the thickness of the magenta color filters becomes thin. Accordingly, the substitution of magenta with white further increases the luminance.

The above description may be applicable to any display device such as a light emitting display or a plasma display panel.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A display device comprising:
a plurality of pixels arranged in matrix, each pixel including a first set of three primary color subpixels and at least one of a second set of three primary color subpixels,
wherein the first and the second sets of three primary colors have a complementary relation.

2. The device of claim 1, wherein the subpixels in each pixel are arranged in a 2 by 2 matrix.

3. The device of claim 2, wherein the first set of three primary color subpixels includes red green, and blue subpixels, and the second set of three primary color subpixels includes cyan, magenta, and yellow subpixels.

4. The device of claim 3, wherein the red and the blue subpixels are arranged in a row and the red and the green subpixels are arranged in a column.

5-14. (canceled)
